(19) United States
(12) Patent Application Publication
(10) Pub. No.: US 2018/0196908 A1
(43) Pub. Date: Jul. 12, 2018

(54) HARDWARE-CONFIGURABLE LOGIC UNIT AND MICROCONTROLLER HAVING SUCH A HARDWARE-CONFIGURABLE LOGIC UNIT

(71) Applicant: Robert Bosch GmbH, Stuttgart (DE)

(72) Inventor: Nico Bannow, Stuttgart (DE)

(21) Appl. No.: 15/861,301

(22) Filed: Jan. 3, 2018

(30) Foreign Application Priority Data
Jan. 12, 2017 (DE) 102017200457.6

(51) Int. Cl. G06F 17/50; G06F 12/0875; G06F 7/78; G06F 15/78

(52) U.S. Cl. CPC G06F 17/5054; G06F 15/7867; G06F 7/785; G06F 12/0875

(57) ABSTRACT

A hardware-configurable logic unit having a plurality of coarse-grain hardware elements and having a control element, the control element being set up to allow a configuration of the coarse-grain hardware elements to be modified.

### CROSS REFERENCE

The present application claims the benefit under 35 U.S.C. § 119 of German Patent Application No. DE 102017200457.6 filed on Jan. 12, 2017, which is expressly incorporated herein by reference in its entirety.

### FIELD

The present invention relates to a hardware-configurable logic unit and to a microcontroller having such a hardware-configurable logic unit.

### BACKGROUND INFORMATION

Conventional digital hardware cannot be modified during runtime. Different functionalities for conventional hardware can, however, be achieved by executing different software. “Conventional digital hardware” is to be understood in this connection in particular to mean processor units (so-called microprocessors or CPUs). A processor unit of this kind can encompass an appropriate processor or processor core, or a multi-core processor made up of several (at least two) processor cores. A processor core usually has an arithmetic logic unit (ALU) for calculating arithmetical and logical functions, and also a local memory. Special hardware accelerators, as a constituent of processors or as discrete components, are also to be associated with conventional digital hardware. In contrast to the software-executing processors, however, the function of the hardware accelerators is hard-wired, so that program code cannot be executed therein.

In contrast thereto, the hardware of a hardware-configurable logic circuit is not unchangeable but can be modified at any time, and in particular can be reprogrammed or reconfigured at a hardware level using a hardware description language (HDL). Different functionalities can thus be assigned to the hardware-configurable logic circuits. Example of hardware-configurable logic circuits are the more-complex field programmable gate arrays (FPGAs) made up of configurable logic blocks (CLBs), as well as more simply constructed (complex) programmable logic devices (CPLDs) made up of programmable AND and OR matrices as well as input and output blocks; these are referred to hereinafter collectively as FPGAs.

Individual circuit regions of an FPGA can be differently interconnected in order to reconfigure FPGAs, a configuration of hardware elements in the individual circuit regions being modified. A different function or functionality of the circuit regions, and thus of the FPGA, is achieved by way of these different configurations. Such hardware elements can be, for example, lookup tables (LUTs), multiplexers (MUXs), signal leads between logic instances (e.g., programmable interconnect points), and/or global resources (clock, Vcc, ground, etc.).

### SUMMARY

The present invention provides a hardware-configurable logic unit and a microcontroller having such a hardware-configurable logic unit. Advantageous embodiments are described herein. The hardware-configurable logic unit has a plurality of coarse-grain hardware elements (i.e., having more than one logic gate) and a control element. The gates are unmodifiable in terms of function and their interconnection. The control element is set up to allow a configuration of the coarse-grain hardware elements to be modified, in particular during normal operation. The hardware-configurable logic unit is in particular a physical unit, more particularly part of an integrated circuit.

“Granularity” is understood in general to mean the degree to which a system is made up of individual elements differing from one another. A coarse-grain system is made up of comparatively few, comparatively large coarse-grain elements, whereas a fine-grain system is made up of comparatively many, comparatively small fine-grain elements.

In specific, granularity in the context of computer architectures can be described by the number of logic gates and, associated therewith, in particular by a correlation between computation operations or processing times, and communication or data exchange. In fine-grain hardware elements (one logic gate each), simple logic operations can be performed quickly in a comparatively short processing time, but data are frequently exchanged between individual elements. In contrast thereto, in coarse-grain hardware elements (several logic gates each), complex operations having comparatively long processing times, in particular, are respectively performed, and data are exchanged less often between individual elements.

“Coarse-grain” hardware elements may thus be understood in particular as elements that can each automatically perform complex computation operations without needing to exchange data with one another for that purpose. Usefully, the individual coarse-grain hardware elements are respectively embodied as one of the following elements: higher-complexity elements such as an arithmetic logic unit (ALU), memory access unit, communication interface; and/or less-complex units such as a comparator, adder, multiplier, divider, shift register, barrel shifter, multiply-accumulate unit, register or register block, memory unit (e.g. RAM, flash, etc.), multiplexer (e.g. 2:1 MUX, M:N MUX).

An ALU calculates, in particular, arithmetical and logical functions. Usefully, it can execute, as a logical function, at least an addition (ADD) as an arithmetical function, and at least a negation (NOT) and a conjunction (AND operation). Preferably it can also carry out, as an arithmetical function, a subtraction (SUB) and/or a comparison (CMP) and/or a multiplication (MUL) and/or a division and/or a decimal adjust after addition. Preferably it can also carry out, as a logical function, a disjunction (OR operation) and/or a contravalence (exclusive OR operation, XOR, EOR) and/or a right and left shift (arithmetic shift right ASR, arithmetic shift left ASL, logical shift right LSR, logical shift left LSL) and/or a left and right rotation (ROL, ROR) and/or register manipulations and/or bit modifications (set, delete, and test bits) and/or resorting of bits and bytes and/or AES commands and/or CRC commands.

A complex computation unit is furnished by way of the individual interconnected coarse-grain hardware elements. The “configuration” of the coarse-grain hardware elements may be understood as the concretization of the function of the coarse-grain hardware elements from the available possibilities and, in particular, also from the connection structure of the individual elements. By modifying the configuration, this computation unit can thus (re)configure the function of the elements at a hardware level and (re)connect the elements to one another in a different way, thereby allowing the computation unit to be adapted to various algorithms at a hardware level.

Conventional hardware-configurable logic circuits, such as FPGAs or CPLDs, usually encompass only fine-grain hardware elements, the configuration of which furthermore can be modified only via external specifications. Conventional hardware-configurable logic circuits of this kind are thus to be regarded as (integrated) circuits that can be programmed at a hardware level in a special programming phase. The same also applies to FPGAs having the capability for partial reconfiguration. Here a corresponding number of function-determining reconfiguration capabilities are reserved but, here as well, are modified on the basis of external specifications, the relevant FPGA sections being correspondingly reprogrammed and interconnected by way of a partial reconfiguration in a respective special reprogramming phase. The reconfigured FPGA sections modify the logic function itself.

In contrast thereto, the hardware-configurable logic unit according to the present invention represents a complex computation unit whose coarse-grain hardware elements can be configured in terms of function, and reconnected to one another, internally by the control element. The internal logic function of the respective individual coarse-grain hardware elements is hard-wired and thus, in contrast to conventional hardware-configurable logic circuits, does not change; it can only be configured and operated in the context of the predefined flexibility.

A reconfiguration of conventional hardware-configurable logic circuits is controlled, carried out, and monitored by an additional unit that is not part of the logic circuit itself but is instead an additional, external unit that conveys corresponding control signals to the conventional logic circuit from outside. Conventional hardware-configurable logic circuits of this kind are thus difficult to integrate into complex computation units such as microcontrollers, since the corresponding computation must, in addition to its further tasks, implement control of the reconfiguration of the logic circuit.

In contrast thereto, reconfiguration of the hardware-configurable logic unit according to the present invention is controlled, carried out, and monitored by the control element and thus by the logic unit itself, i.e., from within. The logic unit can thus independently and automatically reconfigure itself. Unlike with the programming of conventional hardware-configurable logic circuits, the logic unit according to the present invention does not have a special explicit programming cycle. (Re)configuration instead occurs during normal operation as a constituent of the overall algorithm. The hardware-configurable logic unit is thus, particularly advantageously, set up to carry out (re)configuration during normal operation, in particular from within as part of normal operation, and in particular with no need for reconfiguration from outside.

The hardware-configurable logic unit can be implemented particularly advantageously in a higher-order computation unit, for example in a microcontroller. Thanks to the capability of reconfiguring itself, the hardware-configurable logic unit can usefully adapt itself to changing requirements of the higher-order computation unit or to applications to be carried out by it, or on the basis of the data to be processed.

The hardware-configurable logic unit can usefully be combined, in the higher-order computation unit, with non-modifiable hardware, and can in particular exchange data or signals with the latter. The advantages of configurable and non-configurable hardware can be combined thanks to such a combination. Non-configurable hardware for the execution of software has the advantage of maximum flexibility and is applicable to different problems, since corresponding software can be flexibly developed for different application sectors. The performance of the hardware executing such software is, however, limited. Hardware accelerators, as a constituent of processors or as discrete components, likewise possess non-modifiable hardware that as a rule has very high performance, but they have little flexibility because the functionality of such hardware accelerators is hard-wired so that program code cannot be processed therein.

High performance but with high flexibility can be achieved by way of the hardware-configurable logic unit, since it can be configured at a hardware level concretely for processing specific problems and, with different configurations of the coarse-grain hardware elements, can perform different tasks or applications independently, i.e., with no need for time-intensive externally controlled reconfiguration during the processing of complex algorithms, and thus with high efficiency.

Advantageously, the control element is set up to check the (current) configuration or current state of at least one of the coarse-grain hardware elements and, as a result of that check, to modify the (current) configuration of the coarse-grain hardware elements. The information regarding the current configuration of the coarse-grain hardware elements is, in particular, a constituent of the state of the coarse-grain hardware elements, and is correspondingly and usefully available here. The information can also, however, be stored in the control element. In particular, only the former case will be described in detail hereinafter, but the latter case is likewise intended to be included.

Thanks to this checking or evaluation of the current configuration or current state of the coarse-grain hardware elements, the control element can also be regarded as an evaluation circuit. In particular, in the course of this check the control element selects a stored model configuration corresponding to the result of that check, and modifies the current configuration so that it corresponds to the model configuration just selected. The configuration of the logic unit can thus be modified by modifying the stored model configuration.

In particular, the control element can also be configured. Such configuring allows the control element to be flexibly controlled, in particular as a function of changing demands on the logic unit or of applications that the logic unit is to execute. In particular, such configuring allows control to be applied to the control element so as to modify the configuration of the logic unit.

The hardware-configurable logic unit preferably has a second control element that is set up to modify the configuration of the control element. For clearer differentiation, the element hitherto referred to as a “control element” will be referred to hereinafter, with no limitation as to generality, as a “first control element.” The second control element is thus preferably set up to apply control to the first control element. In particular, the first control element checks its own current configuration and the current state of the second control element, in particular its configuration specification. If the current configuration of the first control element and the configuration specification of the second control element differ, the first control element usefully adapts its configuration to the configuration specification of the second control element. It is thereby possible, for example, to modify the stored model configuration so that the first control element is instructed by such control application to correspondingly modify the configuration of the logic unit.

The second control element can in turn usefully be configured or controlled by the logic unit itself, i.e., from within, and/or from outside, i.e. by an external unit connected to the logic unit. This configuration of or application of control to the second control element instructs the latter to correspondingly apply control to the first control element.

Advantageously, the hardware-configurable logic unit has a third control element that is set up to check the configuration and the state of at least one of the coarse-grain hardware elements and/or to check the configuration of the second control element, and to modify the configuration of the second control element as a result of that check. The second control element can thus be reconfigured from within, i.e. by the logic unit itself. In particular, the third control element checks the current configurations and current states of individual coarse-grain hardware elements, as well as the current configuration of the second control element. A change in the configuration of the second control element, or a corresponding application of control to the second control element, by the third control element is usefully possible dynamically during operation of the logic unit.

While a free-standing second control element specifies a respective configuration, in particular quasi-statically, to the first control element, the third control element, because of the dynamic control application to or configuration of the second control element, particularly advantageously enables a resulting dynamic change in the configuration of the hardware-configurable logic unit, with its coarse-grain hardware elements, from within.

Configuration parameters can be evaluated in the third control element in order to configure the second control element so that, for example, dynamic threshold values are set, e.g., as a function of intermediate results; tracking of input models can be carried out; alternative calculation methods can be selected, e.g. once again as a function of intermediate results; logical combinations of individual states can be modified dynamically; and/or multi-stage evaluations can be carried out.

The useful result that can thereby be achieved is that the logic unit can independently and automatically modify its hardware configuration at runtime or during operation. Corresponding configuration of or application of control to the second control element by the third control element, in particular as a function of the current configuration or current states of the coarse-grain hardware elements, causes the second control element to be instructed by the logic unit itself to correspondingly configure or apply control to the control element, so that the first control element correspondingly modifies the hardware configuration of the logic unit.

The hardware-configurable logic unit preferably has an interface for reception of a control signal, the hardware-configurable logic unit being set up to modify a configuration of the second control element upon reception of the control signal. The second control element can thus be configured from outside by the fact that the corresponding external unit transfers a control signal of this kind. Usefully, the configuration values evaluated by the third control element can also be indirectly transferred for this purpose by way of the control signal. Additionally or alternatively to the second control element, the third control element can also itself have such an interface, so that the configuration values are transferred from the external unit directly to the third control element and evaluated there. In particular, only the former case will be described hereinafter in detail, but the latter case is likewise intended to be analogously included. In particular, threshold values and/or a number of loop cycles can be set, and/or individual states to be evaluated, and their logical relationships, can be selected, by way of this configuration. This usefully also creates the possibility that the hardware configuration of the logic unit can be modified not only from within by the logic unit itself, but also from outside by further units.

In order to reduce the complexity of the three control elements, they can be separated. It is advantageous in particular to assign to each coarse-grain hardware element exactly one first, one second, and one third control element. The control elements can be located outside the coarse-grain hardware element or can become a constituent thereof.

If applicable, control elements decoupled by separation are, in particular, equipped with input and output interfaces and with a synchronization mechanism. The input interface is, in particular, capable of detecting and reading in input data of other control elements, and of detecting and implementing the request to start a calculation. The output interface is usefully capable of transmitting output data to other control elements and, if applicable, of transferring the status and the completion of a calculation. The synchronization mechanism ensures functional and correctly timed execution, especially receiving input data, starting calculation, optionally requesting further data, internal progress monitoring, terminating calculation, and outputting calculation results and calculation progress to the output interfaces.

Decoupled control elements preferably exchange the following information with one another via the input and output interfaces: current status, e.g., signaling readiness to accept a new calculation; completed acceptance of input data; progress of the calculation process; (non)completion of a calculation; availability of output data; occurrence of errors; unique identification or allocation of states or data to calculation steps, for example by assigning or maintaining unique IDs; starting or incrementing IDs; etc.

According to a particularly preferred embodiment, the hardware-configurable logic unit is set up to be integrated into a microcontroller as a component. The hardware-configurable logic unit is integrated in particular as an ordinary peripheral unit, thereby enabling communication between the hardware-configurable logic unit and further components of the microprocessor, for example processors or multi-core processors, memory units (RAM, flash, etc.), other peripheral modules (coprocessors, DSPs, interface controllers, etc.), and so forth. High performance and flexibility can be achieved for the microcontroller thanks to the combination of a logic unit with further, in particular non-modifiable, hardware units. Usefully, at least some of the hardware of the microcontroller can thus still be modified so that changing requirements or project-specific applications can be reacted to. It is therefore possible, for example, to introduce into the microcontroller, even in late phases of a development process, functions that can be carried out with high performance directly at a hardware level.

Advantageously, the hardware-configurable logic unit has an interface that is set up to connect the hardware-configurable logic unit in data-transferring fashion to the internal communication system of the microcontroller. Usefully, this internal communication system is embodied as a bus system and/or as signal leads, e.g. a microcontroller bus, system bus, and interrupt leads or, for example, fault output leads. The hardware-configurable logic unit can be integrated as a slave or as a master into the communication system, and can directly access, for example, memory elements (working memory, RAM), other peripheral devices, etc., of the microcontroller via the communication system, in particular via direct memory access (DMA).

Advantageously, the hardware-configurable logic unit has an interface that is set up to connect the hardware-configurable logic unit in data-transferring fashion to an external communication system of the microcontroller. Usefully, this external communication system is embodied as a bus system and/or directly via I/O pins, e.g., SPI, CAN, FlexRay, Ethernet, and/or e.g. as an input pin or output pin or combined input/output pin. The hardware-configurable logic unit can be integrated as a slave or as a master into the communication system.

The internal and external interfaces are preferably furthermore set up to exchange data and/or control signals with further components housed inside or outside the microcontroller. Output data can thus be conveyed from the logic unit via the interface to further components, and input data can be received from them. The interfaces make possible in particular, by way of address-based and/or non-address-based accesses, the reception and transmission of data respectively from and to data registers and/or control registers, internal memory units, interrupt leads, other signal leads. Data exchanged via the interface can serve to control the logic unit and/or can be input data or output data of calculations.

Usefully, the hardware-configurable logic unit is designed, or the individual coarse-grain hardware elements are selected in terms of function, performance, and number, in such a way that all the necessary computation protocols can be mapped; and so that a performance level for computation operations to be carried out is sufficiently high, and a latency time sufficiently short, to meet overall system requirements. For example, coarse-grain hardware elements can be provided and structured in such a way that they advantageously raise the performance level and/or reduce latency time, for example by way of parallel structures or parallel execution of commands or so-called pipeline structures according to which commands to be carried out are broken down into sub-commands.

The structural conformation of the hardware-configurable logic unit, in particular the totality of the coarse-grain hardware elements as well as their adjustable configuration capabilities, in particular including the connection structure of their individual elements, is usefully based on a data flow diagram and/or on a state machine. Here one functional element of the data flow diagram corresponds to one coarse-grain hardware element of the hardware-configurable logic unit. The data flow of the data flow diagram corresponds to the connecting structure of the hardware-configurable logic unit. The hardware-configurable logic unit can preferably possess all the simultaneously utilized functional elements in the form of equivalent coarse-grain hardware elements, as well as the data flow of the data flow diagram in the form of an equivalent connecting structure. The hardware-configurable logic unit can thus be completely mapped and represented in self-contained fashion, including a corresponding interface to the remainder of the microcontroller.

Control-engineering algorithms are typically modeled as a data flow diagram and/or as a state machine. Particularly advantageous for this purpose is a method for direct mapping of corresponding algorithms or controller structures, which are represented as a data flow or as data-flow-like, into the hardware-configurable logic unit, so that said mapping is, in particular, automated (e.g., by code generation). This makes possible a development process that begins with initial modeling (e.g., in Simulink, ASCET). After definition of the algorithms and mapping thereof into a data flow diagram and/or a state machine, the structure of the hardware-configurable logic unit, the totality of the coarse-grain hardware elements, and their configuration possibilities can be derived and created, in particular in program-assisted and thus automated fashion.

A microcontroller according to the present invention has a hardware-configurable logic unit according to the present invention. Advantages and preferred embodiments of a microcontroller according to the present invention are analogously apparent from the description above. The microcontroller is usefully provided for use in a control device, in particular in a control device of a motor vehicle.

Further advantages and embodiments of the present invention are described herein and are shown in the figures.

The present invention is schematically depicted in the figures on the basis of exemplifying embodiments, and is described below with reference to the figures.

### BRIEF DESCRIPTION OF THE DRAWINGS

FIG. 1 schematically shows a preferred embodiment of a hardware-configurable logic unit according to the present invention.

FIG. 2 schematically shows a preferred embodiment of a microcontroller according to the present invention.

FIG. 3 schematically shows another view of a preferred embodiment of a hardware-configurable logic unit according to the present invention.

### DETAILED DESCRIPTION OF EXAMPLE EMBODIMENTS

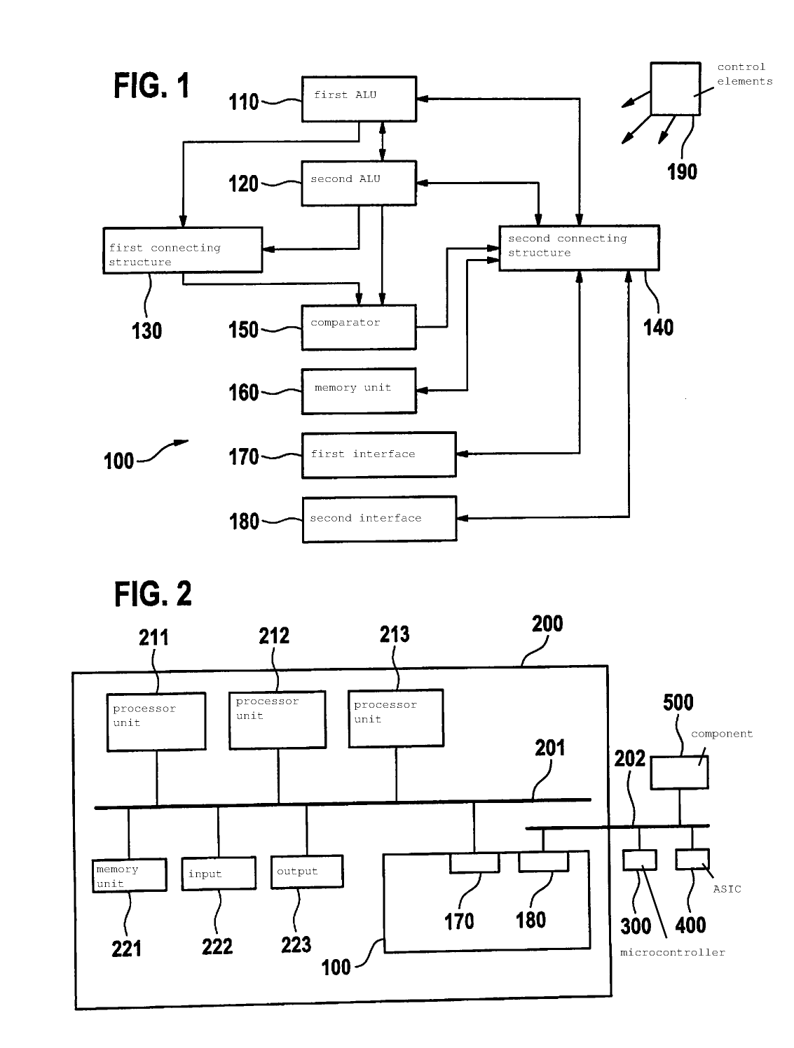

In FIG. 1, a preferred embodiment of a hardware-configurable logic unit according to the present invention is schematically depicted and labeled 100.

Hardware-configurable logic unit 100 has a plurality of coarse-grain hardware elements, i.e. elements having more than one logic gate, for example a first ALU 110, a second ALU 120, a first connecting structure 130, a second connecting structure 140, a comparator 150, a memory unit 160, a first interface 170, and a second interface 180.

Memory unit 160 is embodied, for example, as RAM. First connecting structure 130 is embodied, for example, as a 2:1 multiplexer, and second connecting structure 140 as an M:N multiplexer. Second connecting structure 140 can also be embodied, for example, as a bus system.

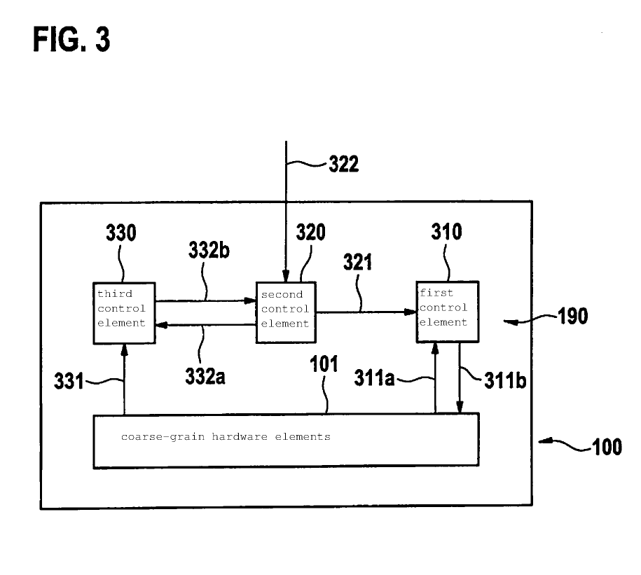

The configuration and connecting structure of the individual coarse-grain hardware elements 110 to 180 can be modified so that hardware-configurable logic unit 100 can be redefined at a hardware level. Logic unit 100 has for this purpose a system of control elements 190 which is set up to modify the configuration of coarse-grain hardware element 110 to 180, as will be explained in detail later with reference to FIG. 3.

Hardware-configurable logic unit 100 can be integrated particularly advantageously as a component into a microcontroller.

In FIG. 2, a preferred embodiment of a microcontroller of this kind according to the present invention is schematically depicted and labeled 200.

Microcontroller 200 can be used, for example, in a control device of a motor vehicle. Microcontroller 200 has an internal communication system 201 that is embodied, for example, as a microcontroller bus. A plurality of internal components are connected to one another in data-transferring fashion via communication system 201. Such components are, for example, processor units (or processor cores) 211, 212, 213 as well as further peripheral elements such as a memory unit 221 in the form of a RAM memory, an input 222 (e.g., bus interface, digital input, ADC, etc.) for connecting microcontroller 200 to sensors and an output 223 (e.g., bus interface, digital output, DAC, etc.) for connecting microcontroller 200 to actuators.

Microcontroller 200 can furthermore have an external communication system 202 that is embodied, for example, as a bus system and/or directly via I/O pins. A plurality of components external to the microcontroller are connected to one another in data-transferring fashion via communication system 202. Such components are, for example, a further microcontroller 300, an ASIC 400, and a further discrete component 500.

Hardware-configurable logic unit 100 according to FIG. 1 is connected in data-transferring fashion via its interface 170 to communication system 201, and via a further interface 180 to communication system 202, constituting further peripheral elements.

Hardware-configurable logic unit 100 can exchange data and signals, via interfaces 170 and 180, with the further components of microcontroller 200 and with external components 300, 400, 500. In particular, hardware-configurable logic unit 100 can receive, via interface 170, control signals according to which the configuration of coarse-grain hardware elements 110 to 180 can be modified. In addition, hardware-configurable logic unit 100 can also independently modify the configuration on its own, as will be described below with reference to FIG. 3.

FIG. 3 schematically depicts, in a different view, hardware-configurable logic unit 100 according to FIG. 1. In the interest of clarity, the coarse-grain hardware elements are not explicitly depicted individually in FIG. 3 but rather are indicated by element 101.

As depicted in FIG. 3, the system of control elements 190 has a first control element 310, a second control element 320, and a third control element 330.

First control element 310 checks the current configuration or current state of coarse-grain hardware elements 101, indicated by reference character 311a. As a result of this check, first control element 310 can modify the current configuration of coarse-grain hardware elements 101, indicated by reference character 311b. First control element 310 controls, monitors, and carries out this reconfiguration.

Second control element 320 can modify and correspondingly apply control to first control element 310, indicated by reference character 321. First control element 310, in particular, likewise checks the current configuration specification of second control element 320. If the current configuration of first control element 310 and the configuration specification of second control element 320 differ, first control element 310 adapts its configuration appropriately to the configuration specification of second control element 320.

Second control element 320 can thus instruct first control element 310 to modify the configuration of coarse-grain hardware elements 101.

By way of a change in the configuration of second control element 320, first control element 310 can thus be instructed to reconfigure coarse-grain hardware elements 101. This configuring of second control element 320, and thus the reconfiguring of coarse-grain hardware elements 101, can be carried out from within by hardware-configurable logic unit 100 itself, or also by further components of microcontroller 200.

For the latter case, a corresponding component of microcontroller 200, for example processor unit 211, can convey a corresponding control signal 322 to hardware-configurable logic unit 100. In response to that signal, second control element 320 is correspondingly configured from outside, for example by the fact that threshold values or a number of loop cycles are set, and that individual states to be evaluated, and the logical combinations thereof, are selected.

Third control element 330 is provided in order to configure second control element 320 from within by way of logic unit 100 itself. Third control element 330 checks the current configuration and the states of the individual coarse-grain hardware elements 101, indicated by reference character 331, as well as the current configuration of second control element 320, indicated by reference character 322a, and on the basis of that check can dynamically configure second control element 320 during the operation of logic unit 100, indicated by reference character 332b, for example by dynamically setting threshold values, tracking input models, selecting alternative computation methods, dynamically modifying logical relationships of individual states, etc.

What is claimed is:

1. A hardware-configurable logic unit, comprising:
a plurality of coarse-grain hardware elements; and
a control element set up to allow a configuration of the coarse-grain hardware elements to be modified.

2. The hardware-configurable logic unit as recited in claim 1, wherein the control element is set up to modify the configuration of the coarse-grain hardware elements during normal operation of the hardware-configurable logic unit.

3. The hardware-configurable logic unit as recited in claim 1, wherein the control element is set up to check the configuration and a state of at least one of the coarse-grain hardware elements, and, as a result of that check, to modify the configuration of the coarse-grain hardware elements.

4. The hardware-configurable logic unit as recited in claim 1, further comprising:
a second control element that is set up to modify the configuration of the control element.

5. The hardware-configurable logic unit as recited in claim 4, further comprising:
an interface to receive a control signal, the hardware-configurable logic unit being set up to modify a configuration of the second control element upon reception of the control signal.

6. The hardware-configurable logic unit as recited in claim 4, further comprising:
a third control element that is set up to at least one of: (i) check the configuration and the state of at least one of the coarse-grain hardware elements, and (ii) check the configuration of the second control element and to modify the configuration of the second control element as a result of that check.

7. The hardware-configurable logic unit as recited in claim 6, wherein one control element, one second control element, and one third control element, being respectively assigned to each coarse-grain hardware element of the plurality of coarse-grain hardware elements.

8. The hardware-configurable logic unit as recited in claim 1, which is set up to be integrated into a microcontroller as a component.

9. The hardware-configurable logic unit as recited in claim 8, further comprising:
an interface that is set up to connect the hardware-configurable logic unit to at least one of: (i) an internal communication system of the microcontroller, and (ii) an external communication system of the microcontroller.

10. The hardware-configurable logic unit as recited in claim 9, wherein the interfaces is set up to exchange at least one of data and control signals, with at least one of further components of the microcontroller, and further external components.

11. The hardware-configurable logic unit as recited claim 1, wherein individual coarse-grain hardware elements of the plurality of coarse-grain hardware elements are respectively embodied as an arithmetic logic unit, register, multiplexer, bus, comparator, memory unit, adder, multiplier, divider, shift register, barrel shifter, multiply-accumulate unit, register block, and interface.

12. The hardware-configurable logic unit as recited in claim 1, which is set up to map algorithms, which are represented as a data flow or as data-flow-like, into the hardware-configurable logic unit.

13. A microcontroller having a hardware-configurable logic unit, the hardware-configurable logic unit comprising:
a plurality of coarse-grain hardware elements; and
a control element set up to allow a configuration of the coarse-grain hardware elements to be modified.
